(19) United States
(12) Patent Application Publication
(10) Pub. No.: US 2009/0089178 A1
(43) Pub. Date: Apr. 2, 2009

(54) System and method for multi-channel, interactive delivery of product information and buying decision information

(76) Inventors: Amy Jo Stark, Plymouth, MN (US); Thomas Koch, Andover, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/906,053

(22) Filed: Sep. 28, 2007

(51) Int. Cl. G06Q 40/00; G06Q 90/00

(52) U.S. Cl. 705/26

(57) ABSTRACT

A system for facilitating multi-channel, interactive delivery of information regarding appliances to customer, to all staff interfacing with customers, and to the retailer's web site is integrated to provide timely and complete information to customer's shopping for an appliance.

### FIELD OF THE INVENTION

The present invention relates generally to a system and method for delivering product information to various employees of a retail operation and to its customers. More particularly, the present invention relates to a system and method for multi-channel interactive delivery of product information to a retail operation's sales force, its customer support team and its customers.

### BACKGROUND OF THE INVENTION

Home appliances includes clothes washers and dryers, ovens, dishwashers, microwaves, cooktop stoves, refrigerators, freezers, vacuums, cooling, heating and air treatment devices, and small appliances such as coffee makers, grills, toasters, toaster ovens, electric can openers, garbage disposals and the like. The consumer is faced with a bevy of options for each such appliance purchase, including a variety of features, capabilities, capacity, sizes, colors and price ranges. Many such appliances are relatively expensive, important to the functioning of a household, and last a relatively long time. Therefore, making the appropriate or optimal choice for a consumer's needs typically requires that the consumer conduct a considerable amount of research, determining what attributes are available in which products so as to make comparisons and ultimately to make an appropriate selection.

### SUMMARY OF THE INVENTION

This product research process can be difficult for a consumer when product information is incomplete or is not available through the venues the consumer may wish to use. For retailers selling appliances, it is a challenge to train its on-the-floor sales force and the various other customer support team members employed by the retailer to assist in supporting and selling to customers regarding appliance products. Adding to the challenge are the frequent changes vendors make to their products; retailers must keep their product information up-to-date, and collect and maintain information for each product they sell, even as their product offerings change. Further, retailers who sell through various channels, such as in-store, online, or over the phone have the challenge of making its product information available through all such channels to accommodate the consumer's choice of channels. Still further, there has been a need to make such information available to consumers all hours of the day, since they may find it most convenient to shop during hours when a store is closed; this is often the case when a previously owned appliance ceases to work and the consumer desire to replace the appliance quickly.

Appliances are often purchased with consideration as to how the appliance will fit within the consumer's home. This is of particular interest during home construction or renovation when dimensions and look of an appliance are coordinated with other design choices for a space, such as a kitchen, great room, laundry/mud room or the like.

What has been needed is a system and method to provide appliance product information to a retailer's sales force, its customer service team and its customers, and for the system and method to make that product information available such that customers can access it via multiple channels, including talking with an informed sales person on the sales floor, operating an in-store kiosk, speaking with a customer service representative, shopping via the retailer's web site, communicating in writing with a customer service representative via instant messaging, or scheduling delivery or installation via a concierge service. Another need has been to maintain up-to-date product information and to provide timely training to its sales force and customer service team, particularly as product offerings change, as product information is updated and as promotions are offered and changed. Another need has been to be able to quiz employees (including on-the-floor sales force and call center representatives) on products and promotions to identify where additional training is required and to assess effectiveness of training.

What has further been needed is a system that provides design tools linked to the product specifications, such that a consumer can select and view an appliance in their floor plan or proposed floor plan, and further to view the appliance in the consumer's planned space in three dimensions from a movable view point.

Yet another need for improving the appliance shopping experience for the consumer has been to provide appliance-specific assistance, such as a phone number dedicated to appliances, leading to a customer service representative particularly trained to answer questions and provide information about appliances. Similarly, there has been a need to provide product-specific training to sales personnel.

There has been a need for retailers who sell and support a variety of products, among which are appliances, to connect customers with sales and customer service staff who have had particular training with respect to appliances, so that the customer gets the benefit of informed sales and service personnel.

### BRIEF DESCRIPTION OF THE DRAWINGS

An exemplary version of a system and method of delivering product information to consumers and a retailer's employees in a multi-channel, interactive way is shown in the figures wherein like reference numerals refer to equivalent structure throughout, and wherein:

FIG. 1 is schematic diagram depicting the entities and information flow involved in the system and method of the present invention.

### DETAILED DESCRIPTION OF PREFERRED EMBODIMENT(S)

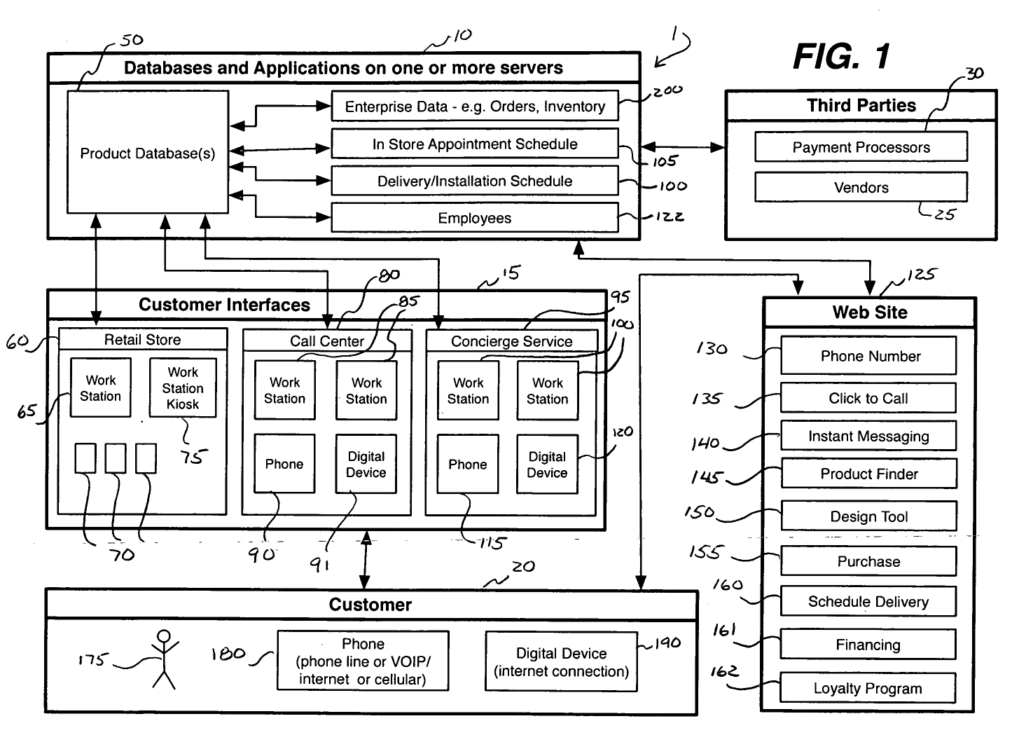

As depicted in FIG. 1, a multi-channel, interactive system 1 and method for delivering information regarding appliances to customers and staff is presented. The system 1 links together a number of entities through various hardware to deliver information stored in a database or series of related databases 10 to a retailer's staff, who are its personal interfaces 15 to customers, and to its customers 20, coordinating with vendors 25, payment processors 30 and various other third parties. Through this linking of information, a retailer is able to provide in-depth, timely information to customers shopping for an appliance. Further, the system links customers to a select group of its sales staff and customer service representatives who have particular training or expertise in appliances so that a customer can engage with the company through any of a number of channels, including in-person conversation within a store; online written communication, and telephone conversation. Still further, the system aids in training and supporting sales staff and customer services representatives by providing them with product information and training materials and, where appropriate, providing access to enterprise information.

The database 10 includes one or more tables or databases 50 storing product records. A product record includes information about the product, including a unique product identifier, and one or more of the following: descriptive text about the product, dimensions, features, one or more images, specifications; capacity and capabilities of the product. Information in the product database 50 is accessible to the retailer's staff 15. “Retailer's staff” as used herein includes employees of the retailer as well as those contracted to operate on behalf of the retailer, such as call center or customer service representatives who may be employed by a third party.

A portion of the retailer's staff is employed as sales associates who work on the sales floor of the retailer's brick and mortar establishments 60, assisting customers with buying decisions. One or more work stations 65 are provided on the sales floor and/or in non-public areas that allow the sales associates to access information stored in the database 50.

As used throughout, “work station” shall include a display and a user input device, such as a keyboard and mouse or touchscreen, coupled to the databases 10, including product database 50, for data transmission therebetween. A “work station” may include data storage, periodically creating a copy of the data in or syncing to the databases 10 or 50, or may access the databases 10 or 50 stored on a remote server via internet, intranet or the like.

In addition, portable digital devices 70 with a display and/or audio output, such as media players, iPods, or the like, are provided to the sales associates. The devices 70 may be connected to or synced to the database through the work station 65 or through other means such as networking, such that the devices 70 display or play product information and/or training materials regarding appliance products or promotions.

Work station kiosks 75 are located in publicly accessible spots within retail stores, and through a display and user input device, allow consumers to access product information. Like workstations 65, the kiosks 75 are coupled to the databases 10, including product database 50, for data transmission therebetween. The work station kiosk 75 may include data storage, periodically creating a copy of the data in or syncing to the databases 10 or 50, or may access the databases 10 or 50 stored on a remote server via internet, intranet or the like.

Any number of retail store locations 15 may be supported by this system; any number of work stations 65 may be incorporated; any number of media players may be incorporated; any number of work station kiosks may be incorporated.

Another portion of the retailer's staff includes call center or customer service representatives who work at a call center 80. The customer service representatives operate one or more work stations 85 at the call center to access the remote databases 10 and 50. The customer service representative at the call center 80 also operates one or more communication devices 90, such as telephones to communicate with consumers. Additional or alternative communication devices include voice-over-internet-protocol devices, devices equipped for online chatting and/or for_instant messaging.

Another portion of the retailer's staff includes concierge service center representatives, who may or may not overlap in whole or in part with the customer service representatives. In practice, the consumer contacts the concierge service 95 to schedule delivery or installation of a purchase item or to schedule an in-store appointment or to schedule a call back. The concierge service center 95 is linked to the databases 10 and support applications, such as scheduling for delivery or installation 100 or scheduling of a call back or in-store appointment 105. The concierge service includes one or more work stations 110, as well as phones 115 or other digital communication devices 120 for communicating with customers 20.

Retailer's staff may access information stored in the database on demand, such as through executing searches or navigating to the desired information through a user interface. In addition, the system may be used to “push” information to the staff, such as by sending notices or information regarding new products or changes to old products or promotions, or by sending a quiz to a staff member regarding a product(s) or promotion. To track staff performance on quizzes or tests, a database 122 may store records associated with staff members and storing their scores.

Data transfer between the databases 10 and any type of device (e.g. work station, kiosk, portable digital device) used by the retailer's staff or customer may be made via a network such as by internet or intranet. Such connections may be wired, wireless, or a combination of wired and wireless.

The content that is delivered to the work stations 65, 85, 110, the digital devices 70, 91, 120, the kiosks 75 or the website 125 may be presented in more than one predetermined language, allowing a user to select their preferred language.

In this system 1, the retailer provides an interactive web site 125 hosted on a server computer. One embodiment of a web site 125 includes a number of features to assist the customers 20 in accessing product information stored in the product database 50. For example, the web site 125 may reference a phone number 130 that a customer 20 may call to access the call center 80. In one embodiment, this phone number is specific to appliances, so that the customer 20 is assured of reaching a call center representative with particular training with regard to appliances. The web site 125 further provides a clickable icon called “Click to Call” 135; when clicked, a window opens and collects information from the customer 20 as to when and how the customer can be contacted.

Another feature of the web site 125 is an instant messaging link 140 that connects to a customer service representative that is particularly trained with regard to appliances, and allows the customer to communicate in writing.

A product finder or shopping assistant 145 on the web site 125 presents a series of multiple choice questions for the consumer 20 to answer through interaction with the web site. Using these answers, the system 1 queries the product database 50 to identify those products that meet the constraints posed by the customer's answers, and returns the results on the web site 125.

Another web site 125 feature is an interactive design tool 150 that allows a customer 20 to enter the layout of a room (e.g. kitchen, wet bar, great room, or the like), and then select appliances to be inserted into the room. This tool 150 accesses the product database 50 to obtain product dimensions and one or more images and inserts properly-sized or proportioned images of products into the user's room. In one embodiment, the interactive design tool 150 has a 3D interface and allows the movement of the “camera” or viewpoint about the room.

The web site 125 includes a purchasing feature 155 that allows a user to initiate a purchase and complete the purchase by providing payment via an online transaction. The purchasing feature 155 accesses the product database 50 to obtain pricing information, including special promotions.

The web site 125 includes a feature by which the customer can schedule delivery and/or installation 160 of a purchased product. This feature accesses the scheduling database and application 100. Customers can also access additional features via the website, such as a financing component (to obtain financing for a purchase) 161 and a loyalty program component (to obtain and use points when making a purchase) 162.

In one embodiment, all features of the system 1, except for retail store hours, are available to the customer 24 hours per day, making it possible for the customer to research, shop for and purchase an appliance at their convenience.

The customer 20 has several options for interacting with the retail establishment, including an in-person visit 175 to a store 60; a phone call 180 to a call center 80 or concierge service center 95; or via a digital device (i.e. connecting to web site 125 via computer, PDA, iPhone®, or any other internet-accessing device) 190. “Webisodes” or videos may be delivered to the user on their computer or phone or media player or can be made available at in-store devices, such as kiosks.

The product database 50 is linked to various other databases 200 maintained by the enterprise, such as inventory data, order data and the like. Via this link, the product database can be updated.

Special orders are accommodated in this system 1, by including special order products in the product database 50. More specifically, special order products can be viewed and ordered via the web site. Further, special orders can be viewed using the design tool.

Although an illustrative version of the device is shown, it should be clear that many modifications to the device may be made without departing from the scope of the invention.

I claim:

1. A system for providing product information to consumers and to retail employees, comprising:
a) a database containing records associated with appliance products, at least some of said records including product dimensions;
b) means for providing said product information to—staff, including sales associates working on sales floor and, call center representatives;
c) means for providing said product information to customers, said means including several information venues; and
d) means for interactively designing customer's living space, said design means being linked to said database, such that said product dimensions are accessible to said design means.

2. A system according to claim 1, further comprising appliance-specific telephone contact number for customers to access a customer service representative who has had appliance-specific training.

3. A system according to claim 10, further comprising appliance-specific click to call icon on said web site to initiate communication with a customer service representative who has had appliance-specific training.

4. A system according to claim 10, wherein said means for providing said product information to customers includes an instant messaging venue, providing written communication between a customer and a customer service representative.

5. A system according to claim 4, wherein said instant messaging venue is appliance-specific and connects a customer to a customer service representative who has had appliance-specific training.

6. A system according to claim 1 wherein said database includes special order products.

7. A system according to claim 1 wherein said design tool allows viewing of a designed room in three dimensions, and provides a user-movable viewing position.

8. A system according to claim 10 wherein said web site includes a product finder feature.

9. A system according to claim 1, wherein said means for providing information to staff includes:
(i) portable media player for displaying appliance-specific information from said database, said media player being linked, at least episodically, to said database for data transmission therebetween; and
(ii) a work station linked to said database for data transmission therebetween, said work stations displaying information stored in said database.

10. A system according to claim 1, wherein said means for providing information to customer includes:
i) web site; and
ii) customer service call center;
each of said venues being linked to said database to provide product information stored in said database.
